(19) United States
(12) Patent Application Publication
(10) Pub. No.: US 2026/0154507 A1
(43) Pub. Date: Jun. 4, 2026

(54) SEMANTIC CACHING FOR DOMAIN-SPECIFIC FEW-SHOT PROMPTING

(71) Applicant: Salesforce, Inc., San Francisco, CA (US)

(72) Inventors: Avi Joel BRENNER, Queen Creek, AZ (US); Ka Man Mary WONG, Vancouver (CA); Vincent TANG, New York, NY (US)

(21) Appl. No.: 18/969,213

(22) Filed: Dec. 4, 2024

(51) Int. Cl. G06F 40/30

(52) U.S. Cl. CPC G06F 40/30

(57) ABSTRACT

A computer system receives a user query for a large language model (LLM). The system encodes the user query into a query vector and queries a semantic cache to determine semantic vectors stored therein that are similar to the query vector. The querying includes determining, for each semantic vector in the semantic cache, a respective semantic similarity score. When the respective semantic similarity score satisfies a threshold score, the computer retrieves a cached response from the semantic cache and returns it as a response to the user query without querying the LLM. When the respective semantic similarity score does not satisfy the threshold score, the system retrieves the cached response, generates a prompt that includes the cached response as one of multiple context examples, inputs the prompt into the LLM, obtains an output from the LLM, and returns the output as the response to the user query.

### TECHNICAL FIELD

The disclosed implementations relate generally to prompt engineering and in particular, to systems, methods, and user interfaces for applying semantic caching to generate domain-specific prompts.

### BACKGROUND

Prompt engineering is the process of creating instructions for artificial intelligence (AI) models to generate desired outputs. A prompt generally comprises natural language text that provides context, instructions, and examples to guide AI models towards generating the desired responses.

### SUMMARY

Prompting techniques are strategies used to guide a language model (e.g., a large language model (LLM)) to generate specific responses based on the input provided. There are many different techniques and literature on how to create prompts to achieve the desired results. Exemplary prompting techniques include: zero-shot prompting, where no examples are given, and the language model is expected to generate a response based solely on its pre-existing knowledge; one-shot prompting, where a single example is provided to illustrate the desired output; few-shot prompting, where a small number of examples (e.g., usually 2-5) are given to help the language model understand the task or pattern; and many-shot prompting, which uses a larger number (e.g., greater than 5 or greater than 10) of examples to clarify the task further. The goal of these techniques is to fine-tune the model's response by providing enough context or structure to guide its behavior, allowing it to generalize the task effectively.

Prompting techniques are essential for making language models more versatile and adaptable to a wide range of tasks without requiring retraining or fine-tuning. Providing examples to a language model as part of a prompt is important because it helps guide the model's behavior, making it more likely to generate accurate, relevant, and contextually appropriate responses.

Currently, examples that are included in prompts tend to be static examples that are used in all prompts, regardless of context. In an organization that includes many domains such as sales, marketing, research and development, and engineering, where each domain essentially represents the organization's respective core functions of generating leads, promoting products/services, and developing the technical aspects of those offerings, generating prompts that span across multiple domains while trying to determine an example set that best aligns with all the possible domains can be difficult.

Accordingly, there is a need for improved systems and methods for developing better prompts having examples that are specific to a user's domain in the organization.

In accordance with some embodiments of the present disclosure is the implementation and application of a semantic cache to better store and retrieve examples with more relevance (e.g., as measured by a semantic similarity score) to the user's query. In some embodiments, the semantic cache (e.g., a vector database) stores all prior generations of user queries and generated responses. In some embodiments, the data entries in the vector database comprise verified responses, meaning that there are signals indicating that these generations are reliable answers.

As disclosed, the semantic cache and the ability of the LLM to generate accurate, relevant, and contextually appropriate responses improve over time, by replacing static canned examples with real-time domain-specific examples.

As disclosed, in some embodiments, a computer system receives a user query for a LLM and encodes the user query as a query vector. The computer system queries a semantic cache of semantic vectors and determines, for each semantic vector of at least a subset of vectors in the semantic cache, a respective similarity score between the query vector and the respective semantic vector. When a respective similarity score between the query vector and a first semantic vector satisfies a first threshold score, the computer system retrieves a first cached response corresponding to the first semantic vector and presents it as the response to the user query without issuing a query to the LLM. When a respective similarity score between the query vector and the first semantic vector does not satisfy a first threshold score (or is between the first threshold score and a second threshold score lower than the first threshold score), the computer system retrieves the first cached response corresponding to the first semantic vector and generates a prompt that includes the first cache response as a context example for querying the LLM. The computer system receives an output from the LLM and presents the output as the response to the user query.

As disclosed, one of the technical benefits of the present disclosure is that the use of a semantic cache removes unnecessary calls to an LLM. Without the novel semantic caching concept, every time a user asks a question, the computer system has to go through the process of generating a prompt and querying the LLM for a response. If a different user asks the same question (e.g., an identical question) again, the computer system has to go through the entire process of prompt generation and LLM querying.

As disclosed, another technical benefit of the present disclosure is that the computer system generates a dynamic prompt (as opposed to static prompts that are used today). Static prompting uses a few generic examples, and the same examples are used over and over again in a prompt, regardless of the user utterance, context, or domain. As disclosed, the semantic cache enables the most similar (e.g., contextually relevant) examples to be retrieved and enables the computer system to dynamically modify the prompt in such a way that only the most relevant examples are used for the prompts. Accordingly, this increases the likelihood that the computer system would generate accurate, relevant, and contextually appropriate responses.

The systems, methods, and user interfaces of this disclosure each have several innovative aspects, no single one of which is solely responsible for the desirable attributes disclosed herein.

In accordance with some embodiments, a method is. performed at a computer system that includes one or more processors and memory. The method includes receiving a user query for a large language model (LLM). The method includes, in response to receiving the user query, encoding the user query into a query vector and querying a semantic cache of semantic vectors to determine one or more semantic vectors stored therein that are similar to the query vector. A respective semantic vector is a vector representation of a previous user query and is associated with a verified response. The querying includes determining, for each semantic vector of at least a subset of semantic vectors in the semantic cache, a respective semantic similarity score between the query vector and the respective semantic vector. The method includes, in accordance with a determination that the respective semantic similarity score between the query vector and the respective semantic vector satisfies a first threshold score: (i) retrieving, from the semantic cache, a cached response corresponding to the respective semantic vector and (ii) returning the cached response as a response to the user query without querying the LLM. The method includes, in accordance with a determination that the respective semantic similarity score between the query vector and the respective semantic vector does not satisfy the first threshold score: (iii) retrieving, from the semantic cache, the cached response corresponding to the respective semantic vector; (iv) generating a prompt that includes the cached response as one of a plurality of context examples; (v) inputting the prompt into the LLM and obtaining, from the LLM, a model output; and (vi) returning the model output as the response to the user query.

In some embodiments, the method includes encoding the user query into the query vector using one or more trained neural networks, where the one or more trained neural network models are trained on a large corpus of words, sentences, and/or data visualizations.

In some embodiments, the method includes generating an index based on at least a subset of semantic vectors in the semantic cache.

In some embodiments, the method includes after returning the model output as the response to the user query, receiving user verification of the model output; and in accordance with receiving the user verification, adding the query vector and the model output as an entry to the index.

In some embodiments, returning the cached response as a response to the user query without querying the LLM includes executing (or causing execution of) a data visualization application, including causing display of a user interface that displays one or more identifications of one or more users who have verified an accuracy of the cached response.

In some embodiments, the plurality of context examples includes a first predefined example. Generating the prompt includes replacing the first predefined example with the cached response.

In accordance with some embodiments, a method for generating semantic caches is performed at a computer system that includes one or more processors and memory. The method includes receiving a user query for a large language model (LLM). The method includes, in accordance with receiving the user query: (i) generating a prompt according to the user query; (ii) inputting the prompt into the LLM; and (iii) obtaining from the LLM a response to the user query. The method includes receiving a user interaction with the response. The method includes, in accordance with a determination that the user interaction is an interaction having a first type, applying an embeddings model to encode the user query as a first semantic vector and storing the first semantic vector and the response in a semantic cache.

In some embodiments, the method includes forming a corpus of training data to be used to generate a target model. The corpus of training data includes a plurality of semantic vectors, including the first semantic vector, each of the plurality of semantic vectors having a corresponding verified response.

In accordance with some embodiments, a computer system includes one or more processors, and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computer system having one or more processors, and memory. The one or more programs include instructions for performing any of the methods disclosed herein.

Thus methods, systems, and graphical user interfaces are disclosed that enable semantic caching for domain-specific prompt generation.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Detailed Description of Implementations below, in conjunction with the following drawings in which like reference numerals refer to corresponding parts throughout the figures.

FIG. 1 is an exemplary workflow for applying a semantic cache to generate prompt examples, in accordance with some embodiments.

FIG. 2A illustrates a process of generating vector embeddings from user queries, in accordance with some embodiments. FIG. 2B illustrates an exemplary vector embedding, in accordance with some embodiments.

FIG. 3 illustrates an example data structure in a semantic cache, in accordance with some embodiments.

FIG. 4 illustrates determining semantic similarity scores between a query vector and respective semantic vectors, in accordance with some embodiments.

FIGS. 5A and 5B are example user interfaces for displaying user queries to an AI model and responses from the AI model, in accordance with some embodiments.

FIG. 6A illustrates an example prompt generated by a computer system prior to the disclosed solution. FIG. 6B illustrates an example prompt generated by a computer system in accordance with embodiment of the present disclosure.

FIG. 7 provides a block diagram of a computing device, in accordance with some embodiments.

FIG. 8 provides a block diagram of a server system, in accordance with some embodiments.

FIGS. 9A to 9D provide a flowchart of a method for analyzing queries, in accordance with some embodiments.

FIG. 10 provides a flowchart of a method for generating semantic caches, in accordance with some embodiments.

### DETAILED DESCRIPTION OF IMPLEMENTATIONS

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

Various embodiments of the present disclosure are directed to methods and systems for generating prompt examples in one-shot, few-shot, or many-shot prompting (where a “shot” is an example) to obtain better outputs from LLMs. In some embodiments, providing an AI model with a few examples of a task can lead to increased accuracy and relevance in model outputs. In some situations, examples that are currently used for generating few-shot prompts tend to be static examples that are used in almost every prompt. In the case of an organization that includes many business units (e.g., domains) such as marketing, research and development, engineering, and customer service, not all of these static examples may be applicable to the respective business unit. In accordance with some embodiments of the present disclosure are methods and systems for dynamically determining (e.g., generating) examples to be included in prompts, where the examples cover all the domains in which they are used. In some embodiments, a semantic cache is applied to retrieve relevant examples based on a user's utterance to use for few-shot prompting. In some embodiments, the semantic cache stores all prior outputs generated in response to user queries and which have been verified by the users (e.g., where there are positive signals that these generations are reliable answers, such as giving a “thumbs-up” or “Like” indications, use of the outputs, storing/saving of the outputs, etc.). The examples that are determined (e.g., selected) are adaptable to the domain of the user utterance, which enables the prompting approach to adapt the few shot examples to different domains and provide more accurate results tuned to the user's utterance.

In accordance with some embodiments of the present disclosure, a computer system includes one or more processors and memory. The computer system receives a user query (e.g., user utterance) for an AI model such as a large language model (LLM). The computer system, in response to receiving the user query, encodes the user query into a query vector. In some embodiments, the computer system encodes the user query into a query vector via an embedding model such as E5 base, text-embedding-ada-002, or intfloat/e5-base-v2. In some embodiments, the query vector is also known as a vector embedding or a text embedding. The computer system queries a semantic cache (e.g., a vector database or an embedding space) of semantic vectors to determine one or more semantic vectors stored therein that are similar to the query vector. In some embodiments, the semantic cache stores (e.g., includes) at least 50,000, at least 100,000, at least 500,000, at least 1000,000 or at least 10,000,000 semantic vectors. The respective semantic vector is a vector representation of a previous user query and is associated with a verified response. For example, the verified response has been confirmed as accurate, valid, or truthful by one or more previous users who have issued the same or a substantially similar query (e.g., to the computer system) and can attest to its validity. For example, a substantially similar query is a query that closely related in meaning, intent, or purpose to another query. In some embodiments, a substantially similar query may use different wording, phrasing, or structure but seek the same or nearly the same information or outcome. The querying includes determining, for each semantic vector of at least a subset of semantic vectors in the semantic cache, a respective semantic similarity score between the query vector and the respective semantic vector. In some embodiments as used herein, the similarity score is computed is based on a predefined metric such as cosine similarity, Euclidean distance, or dot product (e.g., by calculating a distance metric or value between the query vector and the respective semantic vector). The computer system, in accordance with a determination that the respective semantic similarity score between the query vector and the respective semantic vector satisfies a first threshold score, retrieves from the semantic cache a cached response corresponding to the respective semantic vector and returns the cached response as a response to the user query without querying the LLM. The computer system, in accordance with a determination that the respective semantic similarity score between the query vector and the respective semantic vector does not satisfy the first threshold score, (i) retrieves, from the semantic cache, the cached response corresponding to the respective semantic vector, (ii) generates a prompt that includes the cached response as one of a plurality of context examples, (iii) inputs the prompt into the LLM and obtains, from the LLM, a model output, and (iv) returns the model output as the response to the user query.

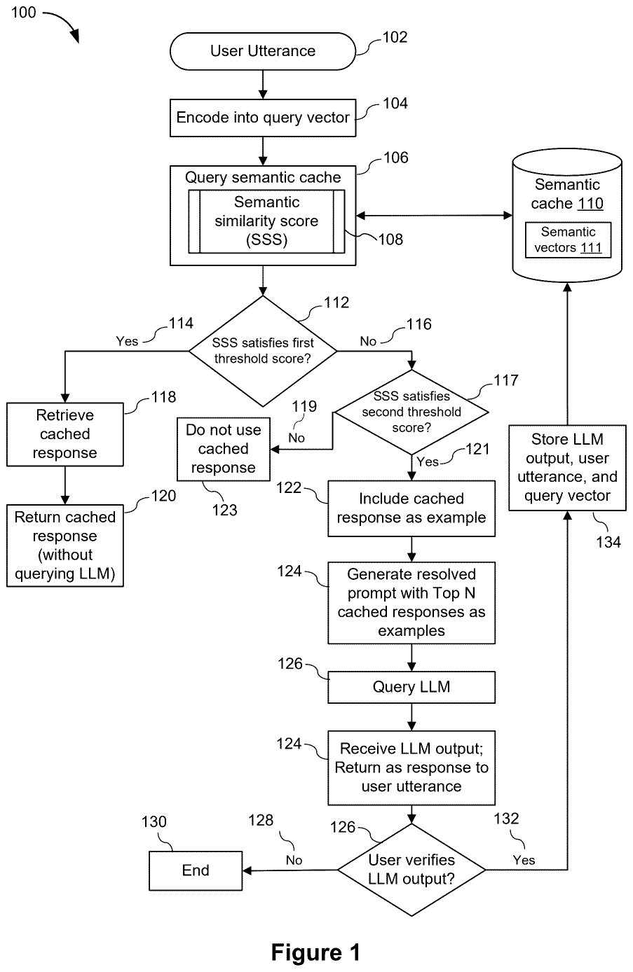

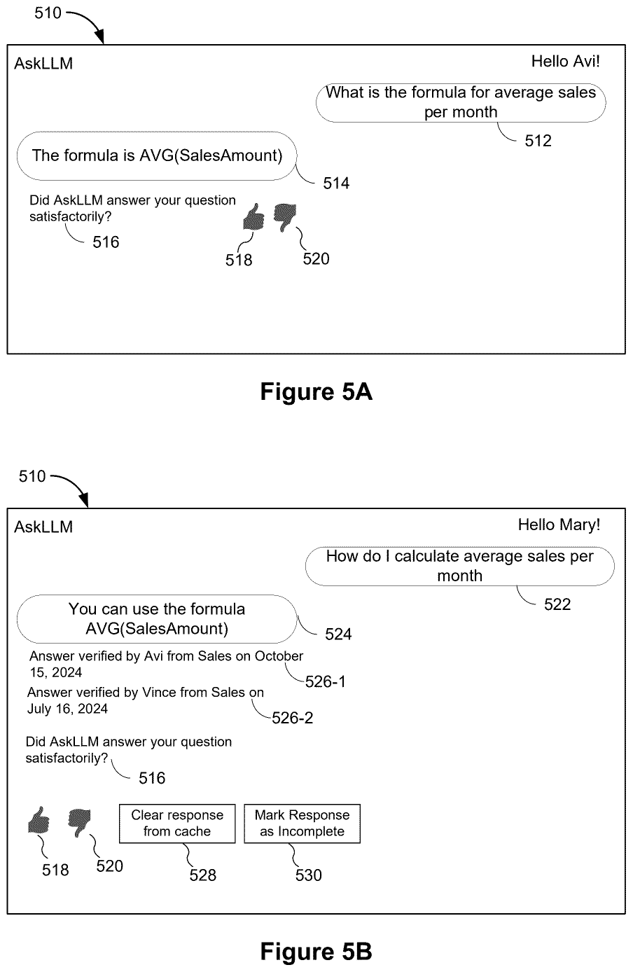

FIG. 1 is an exemplary workflow 100 for generating a semantic cache and applying the semantic cache to generate prompt examples for prompting an AI model, in accordance with some embodiments. In some embodiments, the workflow is executed by a computer system (e.g., computing device 700 and/or computer system 800) that includes one or more processors and memory. The workflow 100 includes receiving a user utterance 102 (e.g., a user query) for an AI model (e.g., data processing models 740 or 840). In some embodiments, the AI model is a LLM (e.g., language model application 750 or language model application 842) or a vision language model. LLMs are advanced machine learning models trained on massive text datasets to understand and generate human-like text. In some embodiments, the AI model is configured to output text, mathematical formulas, reports, data visualizations, data dashboards having two or more data visualizations. The workflow 100 includes encoding (104) the user query into a query vector, and querying (106) the query vector against a semantic cache 110 of semantic vectors 111. In some embodiments, each of the semantic vectors 111 is a vector representation (e.g., numerical vector representation) of a previous user query and is associated with a verified response. In some embodiments, a verified response is a response that has been confirmed as accurate, valid, or truthful by one or more previous users of the organization who have issued the same (or substantially similar) query and can attest to its validity. Further details of annotating a response as a verified response are described with respect to FIGS. 5A and 5B.

In some embodiments, the semantic cache 110 stores (e.g., includes) at least 50,000, at least 100,000, at least 500,000, at least 1000,000 or at least 10,000,000 semantic vectors 111. In some embodiments, the querying includes determining a respective semantic similarity score (SSS) 108 between the query vector and each semantic vector of the semantic vectors that are stored in the semantic cache 110. In some embodiments, the querying includes determining a respective SSS 108 between the query vector and each semantic vector of at least a subset (e.g., at least 10%, at least 25%, at least 50%, or at least 75%) of all the semantic vectors 111 that are stored in the semantic cache 110. In some embodiments, a semantic similarity score is a metric that measures the similarity between two pieces of text based on their meaning and context (e.g., by calculating a distance metric). In some embodiments, the semantic similarity score is a numerical value between 0 and 1, with higher scores indicating greater similarity. In some embodiments, the semantic similarity score is calculated according to a cosine similarity, Jaccard index, Euclidean distance, or dot product.

In some embodiments, at step 112 of the workflow 100, the computer system determines whether the respective SSS 108 between the query vector and the respective semantic vector satisfies a first threshold score. In some embodiments, the first threshold score is a predefined value such as 0.75 or 0.8. In some embodiments, the respective semantic similarity score satisfies the first threshold score when the respective semantic similarity score is greater than or equal to the first threshold score. When the respective similarity score satisfies the first threshold score (denoted by the “Yes” branch 114 in the workflow 100), the computer system retrieves (118) the cached response corresponding to the respective semantic vector from the semantic cache 110, and returns (120) the cached response as a response to the user utterance without querying the LLM. Advantageously, the use of the semantic cache 110 to store and retrieve examples without querying an AI model optimizes compute resources, saves energy (because the AI model does not need to process the query and generate a response), and reduces the amount of time to obtain a response to a query. Thus, the use of the semantic cache 110 improves the operation and performance of the computer system.

Referring back to step 112 of the workflow 100, in some embodiments the respective similarity score does not satisfy the first threshold score (denoted by the “No” branch 116 in the workflow 100). In some embodiments, in accordance with a determination by the computer system that the respective SSS 108 does not satisfy the first threshold score, the computer system determines whether the respective SSS satisfies a second threshold score. In some embodiments, the second threshold score is a predefined value that is smaller than the first threshold score. In one example, the first threshold score is 0.8 and the second threshold score is 0.7. In another example, the first threshold score is 0.75 and the second threshold score is 0.65. In some embodiments, when the computer system determines that the respective SSS 108 does not satisfy the second threshold score, as indicated by the “No” branch 119, the computer system refrains from using or taking further action on the respective cached response (step 123). In some embodiments, when the computer system determines that the respective SSS 108 satisfies the second threshold score (denoted by the “Yes” branch 121 in FIG. 1), the computer system retrieves the respective cached response and includes the respective cached response as a contextual example in a prompt to be generated by the computer system for input into the AI model (e.g., LLM). In some embodiments, the computer system repeats the steps of querying (step 106) the semantic cache 110 and determining the respective SSS for other semantic vectors 111 in the semantic cache 110, to obtain N cached responses (or the top N cached responses) whose respective semantic similarity scores that are between the first threshold score and the second threshold score. In some embodiments, N is a positive integer with a value from 1 to 5 inclusive. In some embodiments, N is a positive integer with a value from 1 to 10 inclusive. At step 124 of the workflow, the computer system generates (124) a resolved prompt with the N cached responses (or the top N cached responses) as examples. At step 126, the computer system queries the LLM using the prompt. At step 128, the computer system receives an output from the LLM and returns the output as a response to the user utterance.

With continued reference to FIG. 1, in some embodiments, after returning the output as a response to the user utterance, the computer system determines whether the user has verified the LLM output, as illustrated in step 126 of the workflow 100. In some embodiments, the workflow ends when the computer system does not receive user verification of the response (“No” in step 128). In some embodiments, when the computer system receives user verification of the response (“Yes” in step 132), the computer system stores (134) the output from the LLM, the user utterance, and the query vector as an entry in the semantic cache 110. Example embodiments of obtaining user verification of the response are described in FIGS. 5A and 5B.

In accordance with some embodiments of the present disclosure, eliciting feedback from users, and storing verified responses and their corresponding queries in the semantic cache 110, as illustrated in the workflow 100, builds a database of better examples for prompt generation over time. This, in turn, improves the AI model because the use of contextually-and domain-relevant queries and responses as examples for prompts can enable the AI model generate outputs with increased accuracy and relevance.

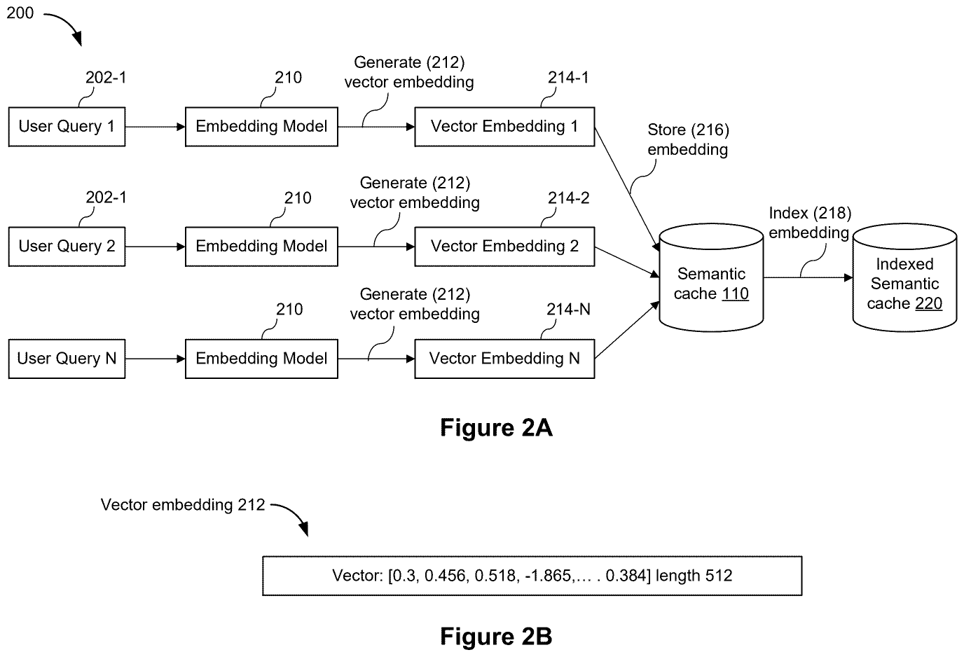

FIG. 2A illustrates a process 200 for generating vector embeddings 214 (e.g., query vectors, vector data, or data points represented as vectors) (e.g., vector embeddings 214-1, 214-2 to 214-N) from user queries (e.g., user queries 202-1, 202-2 to 202-N), in accordance with some embodiments. Some embodiments generate vector embeddings 214 from user queries 202 using an embedding model 210 (e.g., data processing models 740 or 840). Example embedding models include E5 base, text-embedding-ada-002, or intfloat/e5-base-v2. In some embodiments, the vector embeddings are stored in a comma-separated values file (a CSV file) or using a similar file format. In some embodiments, the vector embeddings 214 are stored in a semantic cache 110. In some embodiments, the semantic cache 110 is also known as a vector database, which is a database that allows one efficiently store and query embedding data. Vector databases extend the capabilities of traditional relational databases to embeddings. In some embodiments, a key distinguishing feature of a vector database is that query results may not be an exact match to the query. Instead, using a specified similarity metric (e.g., cosine similarity, Jaccard index, Euclidean distance, or dot product), the vector database returns embeddings that are similar to a query. In some embodiments, the process 200 includes indexing (218) the embeddings 214 to generate an indexed semantic cache 220. In some embodiments, the indexing 218 includes organizing and structuring the high-dimensional vector embeddings 214 to enable efficient search and retrieval. In some embodiments, the indexing 218 includes creating a data structure that optimizes similarity searches, where the goal is to find vectors that are closest to a given query vector based on a similarity metric like cosine similarity, Jaccard index, Euclidean distance, or dot product. In some embodiments, the computer system applies indexing techniques such as tree-based methods, hashing techniques, graph-based methods, and/or quantization methods to index the data in the semantic cache 110.

FIG. 2B illustrates an exemplary vector embedding 212, in accordance with some embodiments. The vector embedding 212 is a numerical representation of data in a high-dimensional vector space, such as a 128, 512, or 768 dimension space, where each dimension represents a specific feature or aspect of the data.

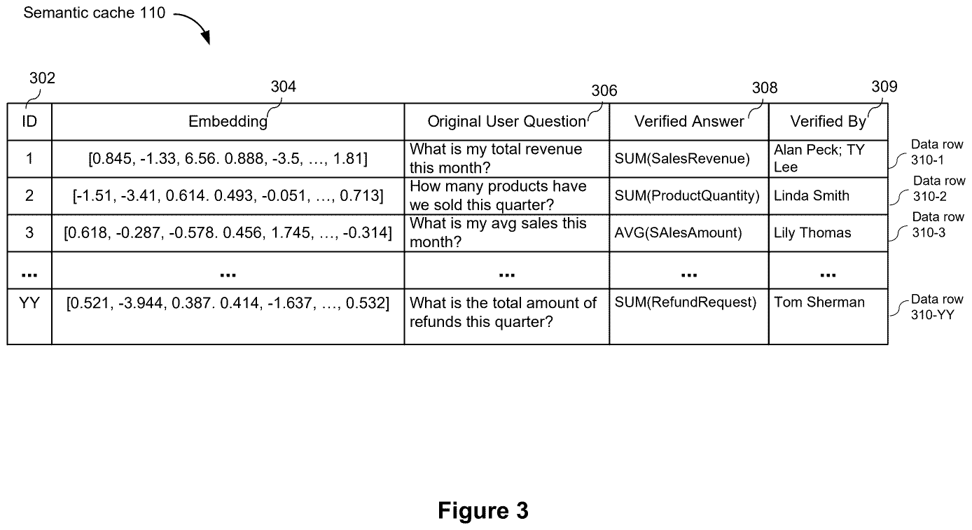

FIG. 3 illustrates an example data structure in a semantic cache 110, in accordance with some embodiments. In some embodiments, the semantic cache 110 includes multiple data rows 310 (e.g., data row 310-1 to data row 310-YY), where each data row is associated with a respective ID 302, a respective corresponding embedding 304, a respective original user question 306, and a respective verified answer 308 (e.g., a verified response). In some embodiments, the semantic cache 110 is a data bank of verified answers (e.g., verified responses) and the data rows 310 further include information 309 identifying one or more users who have confirmed that the answer to the question is accurate, valid, or truthful. IN some embodiments, the one or more users who have verified an answer are users who have issued the same (or substantially similar) query, or have previously used the answer, or have previously saved the answer and can attest to its validity.

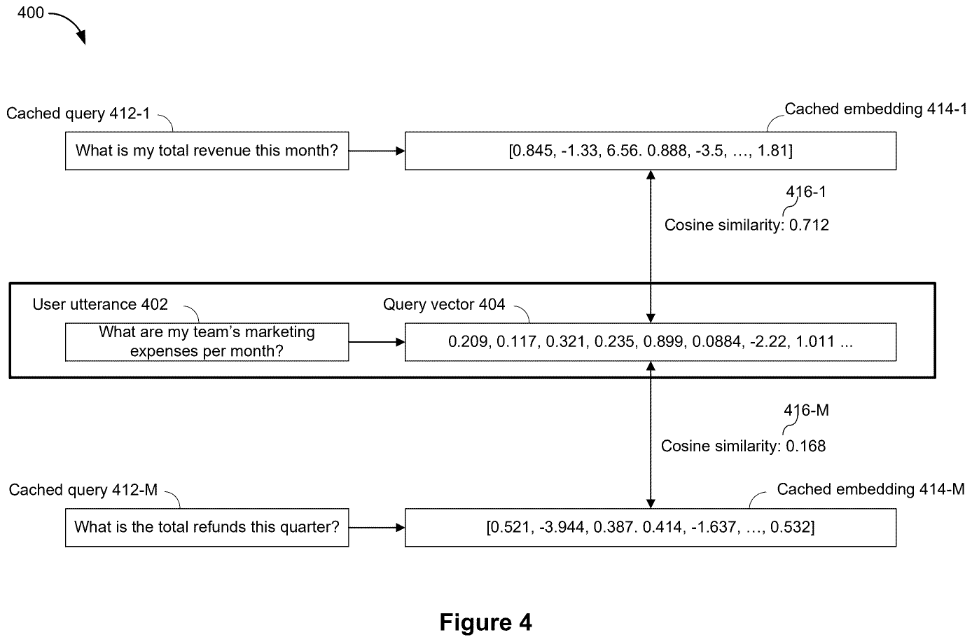

FIG. 4 illustrates determining semantic similarity scores between a query vector and respective semantic vectors, in accordance with some embodiments.

As illustrated in FIG. 4, a user utterance 402 (e.g., “What are my team's marketing expenses per month?”) is encoded into a query vector 404 and queried against cached embeddings 414 (e.g., cached embedding 414-1 and cached embedding 414-M, or embeddings 304) that are stored in the semantic cache 110. Each cached embedding 414 corresponds to one respective cached query (e.g., cached query 412-1 and cached query 412-M) that is also stored in the semantic cache. In the example of FIG. 4, a cosine similarity 416 (e.g., cosine similarity 416-1 and cosine similarity 416-M) is determined between the query vector 404 and a respective cached embedding 414 to determine the similarity between the user utterance 402 and the respective cached cached query 412.

FIGS. 5A and 5B are example user interfaces 510 for displaying user queries to an AI model and responses from the AI model, in accordance with some embodiments.

In the example of FIG. 5A, a user Avi inputs a query 512 (e.g., “What is the formula for average sales per month”) to a computer system executing an AI model (e.g., data processing models 740 or 840). The computer system (e.g., by executing the AI model or by determining via a semantic cache) outputs a response 514 “The formula is AVG(SalesAmount)” that is responsive to the query 512. In some embodiments, the computer system concurrently displays (or causes display of) the response 514 and a survey question 516 via the user interface 510. The survey question 516 seeks to find out from the user whether the response 514 answers the question to the user's satisfaction. In some embodiments, the user interface 510 concurrently displays with the survey question 516 a thumbs-up (e.g., like) affordance 518 and a thumbs-down (or dislike) affordance 520. User selection of the thumbs-up affordance 518 indicates to the computer system that the user approves the response as being accurate and valid, whereas user selection of the thumbs-down affordance 520 indicates to the computer system that the user does not approve the response or does not consider the response to be accurate or responsive to the query. In some embodiments, in response to user selection of the thumbs-up affordance 518, the computer system annotates (or causes annotation of) the response as a verified response. In some embodiments, in response to user selection of the thumbs-up affordance 518, the computer system stores the response 514 and the query 512 as a data row in a semantic cache 110. In some embodiments, in response to user selection of the thumbs-down affordance 520, the computer system refrains from taking further action on the response (i.e., the computer system does not save the response in the semantic cache 110). Let us suppose that in the example of FIG. 5A, the user selects the thumbs-up affordance 518.

FIG. 5B illustrates another view of the user interface 510 in accordance with some embodiments. The example of FIG. 5B may occur later in time than FIG. 5A. In FIG. 5B, a user Mary inputs a query 522 (e.g., “Calculate average sales per month”) to the computer system executing the AI model. In some embodiments, and as explained above with respect to FIGS. 1 and 2A, in response to receiving a query, such as the query 522, the computer system converts the query into a query vector (e.g., vector embedding) embedding and queries a semantic cache (e.g., semantic cache) 110 to determine whether there are semantic vector(s) that are substantially similar to the query vector. In some embodiments, a semantic vector is substantially similar to the query vector when a semantic similarity score between the semantic vector and the query vector satisfies the first threshold score, as illustrated in step 114 of the workflow 100 in FIG. 1. Stated another way, in some embodiments, a first query (e.g., query 512) and a second query (e.g., query 522) are substantially similar when they are closely related in meaning, intent, or purpose. In some instances, the second query may use different wordings, phrasing, or structure, but seeks the same or nearly the same information or outcome as the first query. In this example, the computer system determines that the query 522 is substantially similar to a previous query 512. In accordance with this determination, the computer system retrieves (e.g., from the semantic cache 110) the response (e.g., a verified response) corresponding to the query 512 and displays it on the user interface 510 as the response 524 (e.g., “You can use the formula AVG(SalesAmount)”). FIG. 5B also shows that in some embodiments, the user interface 510 also displays indications 526 (e.g., indications 526-1 and 526-2) that include identifications of one or more users who have verified the response. In some embodiments, the indications 526 include a respective date on which the response was verified. In some embodiments, the user interface 510 displays the survey question 516 to find out from the user whether the AI model has answered the question to the user's satisfaction, along with the thumbs-up affordance 518 and the thumbs-down affordance 520, as explained above with respect to FIG. 5A.

As further illustrated in FIG. 5B, in some embodiments, the user interface 510 displays a user-selectable option 528 that, when selected by a user, clears (e.g., removes) the response (e.g., answer) from the semantic cache 110. In some embodiments, the user interface 510 displays a user-selectable option 530 that, when selected by a user, causes the answer to be annotated (e.g., marked) as an incomplete answer in the semantic cache. In some embodiments, responses in the semantic cache that have been marked as incomplete can be used only as examples (e.g., for prompting) but not full answers are returned as cached responses.

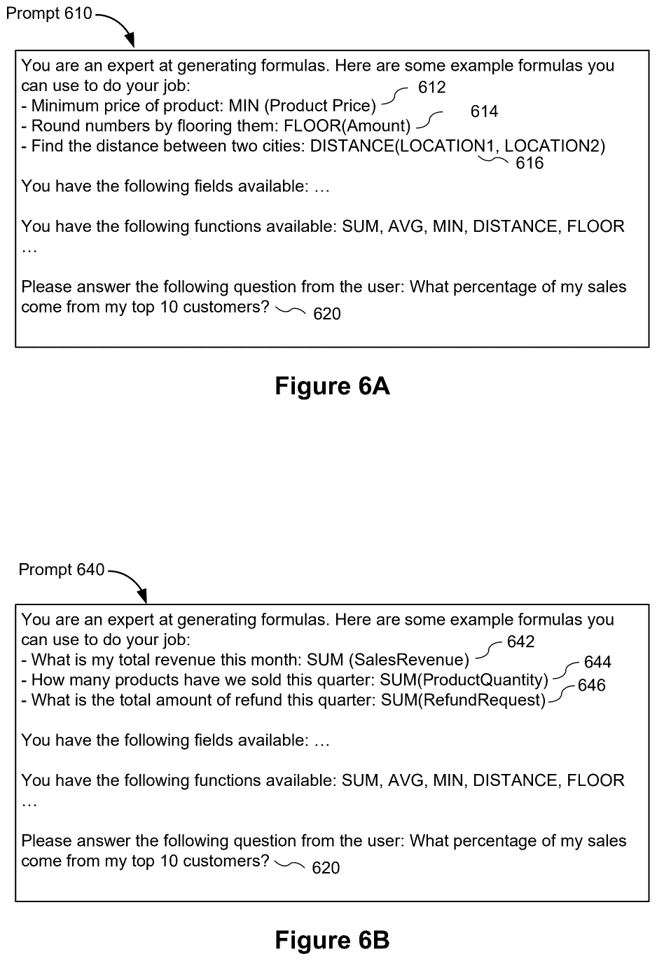

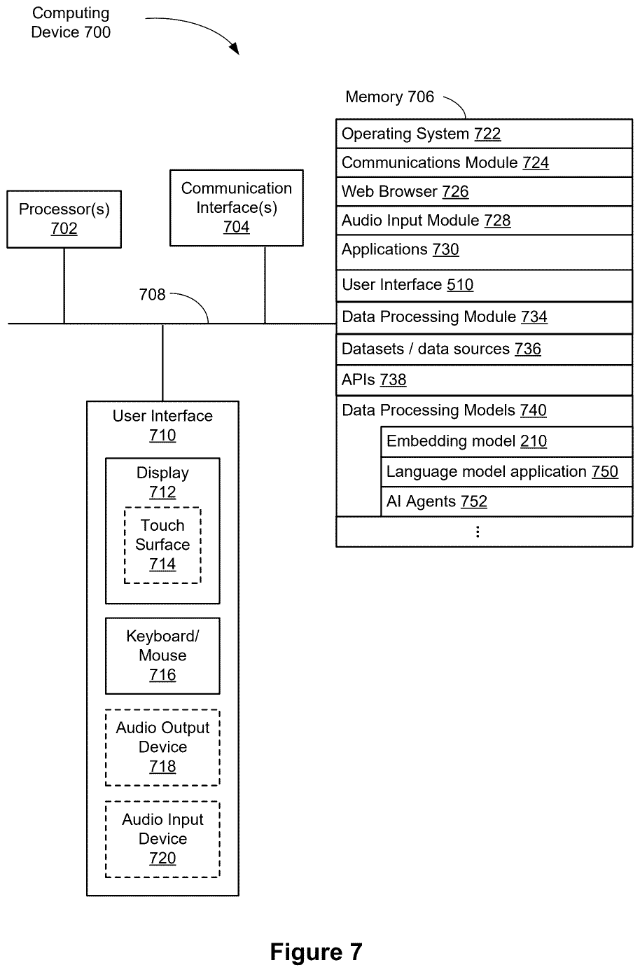

FIG. 6A illustrates an example prompt 610 generated by a computer system prior to the technical solutions disclosed herein. The prompt 610 includes examples 612, 614, and 616 and a query 620. In some embodiments, the examples 612, 614, and 616 are the same examples that are used in most if not or all prompts generated by the computer system, regardless of context. Specifically, the query 620 has to do with what percentage of a user's sales come from the user's top 10 customers, but the example 616 (“Find the distance between two cities: DISTANCE(LOCATION1, LOCATION2)”) is not relevant to the query 620.

FIG. 6B illustrates an example prompt 640 generated by a computer system in accordance with the present disclosure. The prompt 640 includes a different set of examples 642, 644, and 646 and the same query 620. In FIG. 6B, the examples 642, 644, and 646 are previous user queries and verified responses retrieved from the semantic cache 110, as discussed above with reference to FIGS. 1, 3, and 4. Compared to the examples 612, 614, and 616 in FIG. 6A, the examples 642, 644, and 646 in FIG. 6B are more relevant to the context and the domain of the query 620.

FIG. 7 is a block diagram of a computing device 700 for processing queries, in accordance with some embodiments. Various examples of the computing device 700 include a desktop computer, a laptop computer, a tablet computer, and other computing devices that have a display and a processor capable of running applications 730. In some embodiments, the computing device 700 is a virtual reality (VR) device, an augmented reality (AR) device, or a spatial computing device that blends digital content with the physical world. The computing device 700 typically includes one or more processing units (processors) 702, one or more network or other communication interfaces 704, memory 706, and one or more communication buses 708 for interconnecting these components. In some embodiments, the communication buses 708 include circuitry (sometimes called a chipset) that interconnects and controls communications between system components.

The computing device 700 includes a user interface 710. The user interface 710 typically includes a display device 712 (e.g., a display generation component). In some embodiments, the computing device 700 includes input devices such as a keyboard, mouse, and/or other input buttons 716. Alternatively or in addition, in some embodiments, the display device 712 includes a touch-sensitive surface 714, in which case the display device 712 is a touch-sensitive display. In some embodiments, the touch-sensitive surface 714 is configured to detect various swipe gestures (e.g., continuous gestures in vertical and/or horizontal directions) and/or other gestures (e.g., single/double tap). In computing devices that have a touch-sensitive display 714, a physical keyboard is optional (e.g., a soft keyboard may be displayed when keyboard entry is needed). The user interface 710 also includes an audio output device 718, such as speakers or an audio output connection connected to speakers, earphones, or headphones. Furthermore, some computing devices 700 use a microphone and voice recognition to supplement or replace the keyboard. In some embodiments, the computing device 700 includes an audio input device 720 (e.g., a microphone) to capture audio (e.g., speech from a user).

In some embodiments, the memory 706 includes high-speed random-access memory, such as DRAM, SRAM, DDR RAM, or other random-access solid-state memory devices. In some embodiments, the memory 706 includes non-volatile memory, such as one or more magnetic disk storage devices, optical disk storage devices, flash memory devices, or other non-volatile solid-state storage devices. In some embodiments, the memory 706 includes one or more storage devices remotely located from the processors 702. The memory 206, or alternatively the non-volatile memory devices within the memory 706, includes a non-transitory computer-readable storage medium. In some embodiments, the memory 2706, or the computer-readable storage medium of the memory 206, stores the following programs, modules, and data structures, or a subset or superset thereof:
an operating system 722, which includes procedures for handling various basic system services and for performing hardware dependent tasks;
a communications module 724, which is used for connecting the computing device 700 to other computers (e.g., computer system 800) and devices via the one or more communication interfaces 704 (wired or wireless), such as the Internet, other wide area networks, local area networks, metropolitan area networks, and so on;
a web browser 726 (or other application capable of displaying web pages), which enables a user to communicate over a network with remote computers or devices;
an audio input module 728 (e.g., a microphone module), which processes audio captured by the audio input device 720. The captured audio may be sent to a remote server (e.g., computer system 800) and/or processed by an application executing on the computing device 700 (e.g., the applications 730);
one or more applications 730 for execution by the computing device 700;
a user interface 510;
a data processing module 734 for processing queries. In some embodiments, the data processing module 734 uses data processing models 740 to process the data; and
zero or more datasets or data sources 736, which are used by the applications 730 or the data processing models 740. In some embodiments, the datasets/data sources 736 include data fields and data values corresponding to the data fields;
APIs 738 for receiving API calls from one or more applications, translating the API calls into appropriate actions, and performing one or more actions; and
data processing models 740 (e.g., AI models) for processing datasets/data sources 736 or processing user queries. In some embodiments, the data processing models 740 include one or more embedding models 210, one or more language model applications 750 (e.g., large language models (LLMs)), and/or one or more AI agents 752.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some embodiments, the memory 206 stores a subset of the modules and data structures identified above. Furthermore, the memory 206 may store additional modules or data structures not described above. In some embodiments, a subset of the programs, modules, and/or data stored in the memory 206 is stored on and/or executed by a server system 300.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of interval or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

Although FIG. 7 shows a computing device 700, FIG. 7 is intended more as a functional description of the various features that may be present rather than as a structural schematic of the implementations described herein. In practice, and as recognized by those of ordinary skill in the art, items shown separately could be combined and some items could be separated. In addition, some of the programs, functions, procedures, or data shown above with respect to the computing device 700 may be stored or executed on a server system (e.g., computer system 800).

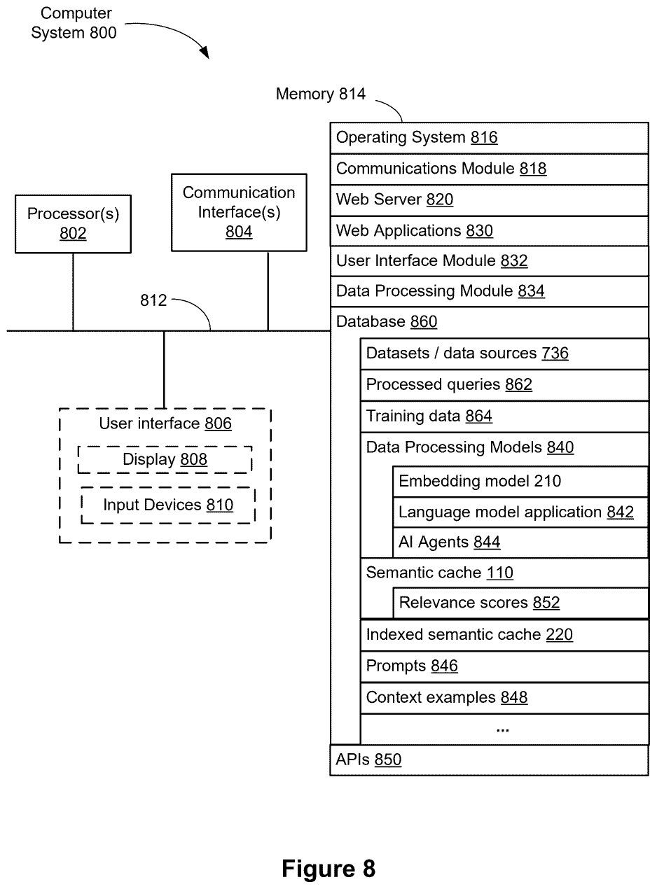

FIG. 8 is a block diagram of a computer system 800 (e.g., a server system), in accordance with some embodiments. The server system 800 typically includes one or more processing units/cores (CPUs) 802, one or more network interfaces 804, memory 814, and one or more communication buses 812 for interconnecting these components. In some embodiments, the computer system 800 includes a user interface 806, which includes a display 808 and one or more input devices 810, such as a keyboard and a mouse. In some embodiments, the communication buses 812 include circuitry (sometimes called a chipset) that interconnects and controls communications between system components.

In some embodiments, the memory 814 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. In some embodiments, the memory 814 includes one or more storage devices remotely located from the CPUs 802. The memory 814, or alternatively the non-volatile memory devices within the memory 814, comprises a non-transitory computer readable storage medium.

In some embodiments, the memory 814 or the computer readable storage medium of the memory 814 stores the following programs, modules, and data structures, or a subset thereof:
an operating system 816, which includes procedures for handling various basic system services and for performing hardware dependent tasks;
a network communications module 818, which is used for connecting the computer system 800 to other computers via the one or more communication network interfaces 804 (wired or wireless) and one or more communication networks, such as the Internet, other wide area networks, local area networks, metropolitan area networks, and so on;
a web server 820 (such as an HTTP server), which receives web requests from users and responds by providing responsive web pages or other resources;
web applications 830 for execution by the computer system 800. In some embodiments, the web applications 830 may be downloaded and executed by a web browser 226 on a user's computing device 700. In general, web applications 830 have the same functionality as desktop applications 730, but provides the flexibility of access from any device at any location with network connectivity, and does not require installation and maintenance;
a user interface module 832, which provides the user interface for all aspects of the web applications 830;
a data processing module 834, which has the same functionality as data processing module 734;

In some embodiments, the computer system 800 includes a database 860. In some embodiments, the database 860 includes zero or more datasets or data sources 736, which are used by the web applications 830 and/or the data processing models 834. In some embodiments, the database 860 includes processed queries 862 (e.g., previous queries) and training data 864 for training the data processing models 840. In some embodiments, the training data comprise semantic vectors (e.g., embeddings). In some embodiments, the database 860 stores one or more data processing models 840, including one or more embedding models 210, one or more language model applications 842 (e.g., large language models (LLMs)), and/or one or more AI agents 844. In some embodiments, the database 860 includes a semantic cache 110 and an indexed semantic cache 220, as discussed with respect to FIGS. 1, 2A, 2B, and 3. In some embodiments, the verified answers in the semantic cache 110 are associated with corresponding relevance scores 852 that can indicate a relevance, freshness, or staleness of the responses. In some embodiments, the database 860 stores prompts 846 and context examples 848 to be included in prompts for the data processing models 840.

In some embodiments, the memory 814 stores APIs 850 for receiving API calls from one or more applications (e.g., a web server 820, web applications 830, and/or data processing models 840), translating the API calls into appropriate actions, and performing one or more actions.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some embodiments, the memory 814 stores a subset of the modules and data structures identified above. Furthermore, the memory 814 may store additional modules or data structures not described above.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of interval or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

Although FIG. 8 shows a computer system 800 (e.g., server system), FIG. 8 is intended more as a functional description of the various features that may be present rather than as a structural schematic of the implementations described herein. In practice, and as recognized by those of ordinary skill in the art, items shown separately could be combined and some items could be separated. In addition, some of the programs, functions, procedures, or data shown above with respect to a computer system 800 may be stored or executed on a computing device 700. In some embodiments, the functionality and/or data may be allocated between a computing device 700 and one or more computer systems 800. Furthermore, one of skill in the art recognizes that FIG. 8 need not represent a single physical device. In some embodiments, the server functionality is allocated across multiple physical devices in a server system. As used herein, references to a “server” include various groups, collections, or arrays of servers that provide the described functionality, and the physical servers need not be physically colocated (e.g., the individual physical devices could be spread throughout the United States or throughout the world).

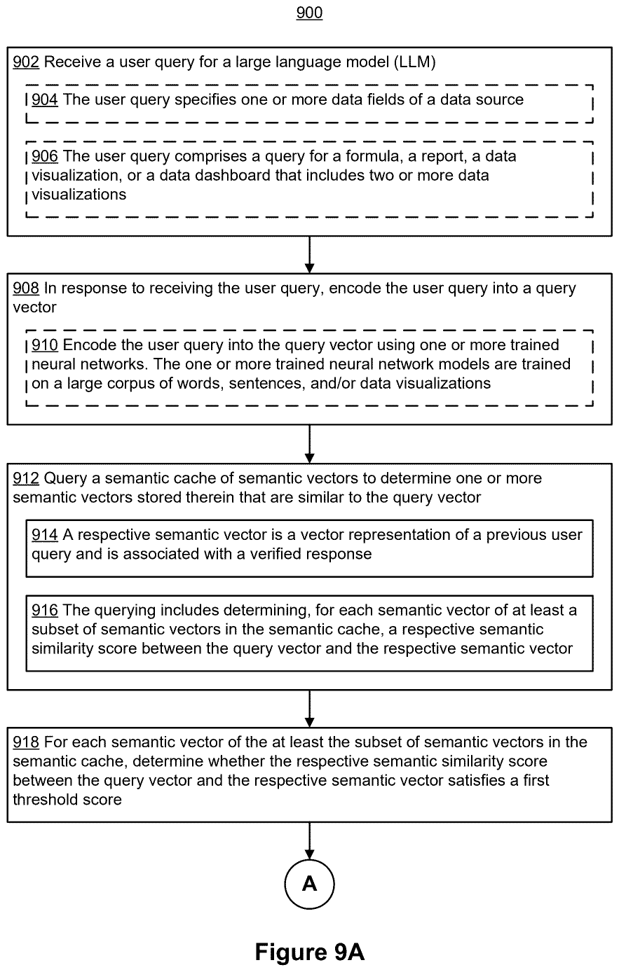

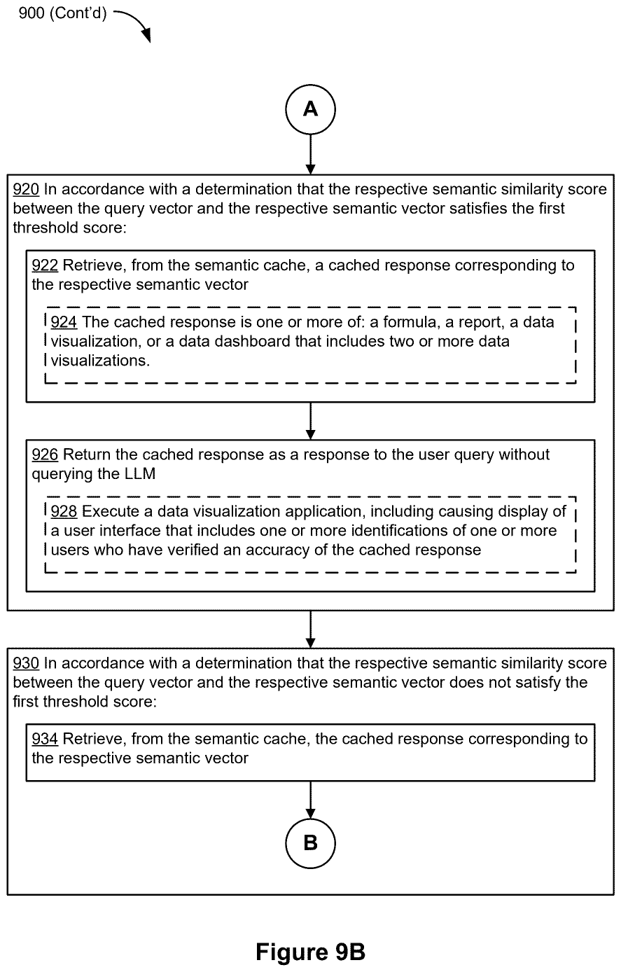

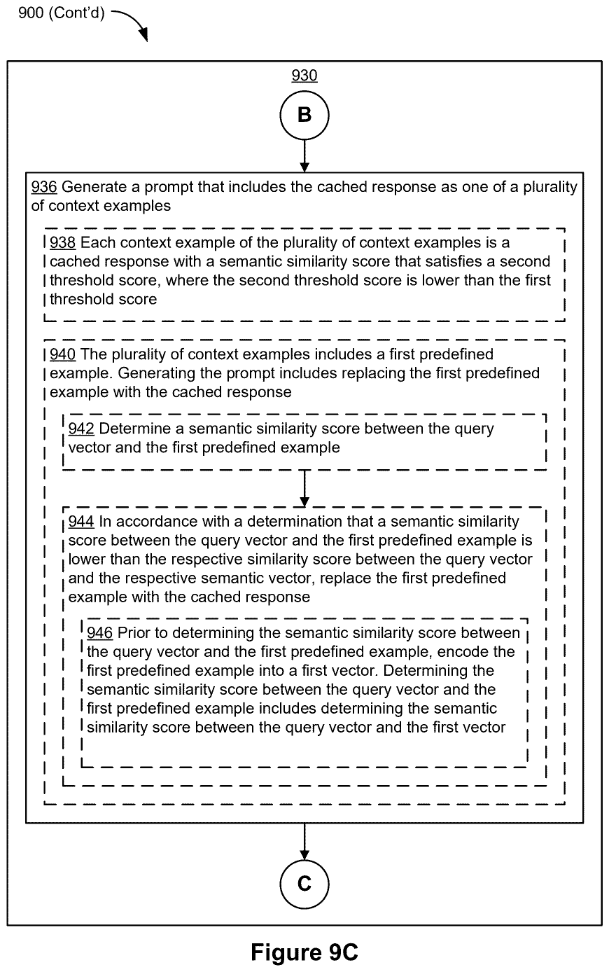

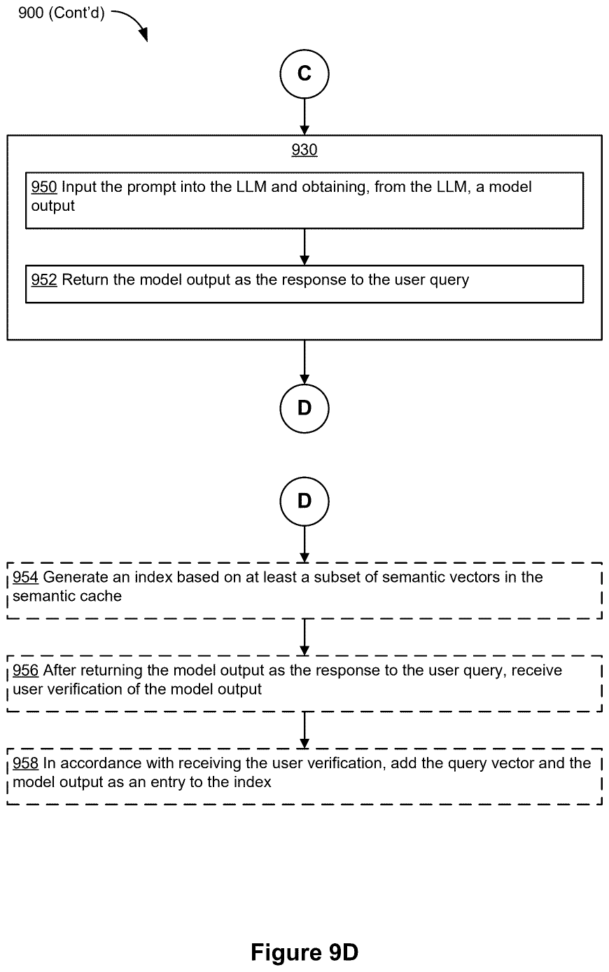

FIGS. 9A to 9D provide a flowchart of an example process for processing queries, in accordance with some embodiments. The method 900 is performed at a computer system (e.g., computing device 700 or computer system 800) that includes one or more processors (e.g., processor(s) 702 or processor(s) 802) and memory (e.g., memory 706 or memory 814). The memory stores one or more programs configured for execution by the one or more processors. In some embodiments, the operations shown in FIGS. 1, 2A, 2B, 3, 4, 5A, 5B, 6A, and 6B correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 900 may be combined (e.g., with the method 1000) and/or the order of some operations may be changed.

Referring to FIG. 9A, the computer system receives (902) a user query (e.g., user utterance) for a large language model (LLM) (e.g., data processing models 740 or 840).

In some embodiments, the user query specifies (904) one or more data fields of a data source. An example data source is the “Superstore” data source and exemplary data fields of the “Superstore” data source can include “Furniture,” “Technology,” “state,” “ship mode,” and “customer name.”

In some embodiments, the user query comprises (906) a query for a formula, a report, a data visualization, or a data dashboard that includes two or more data visualizations.

The computer system, in response to receiving the user query, encodes (908) (e.g., via embedding model 210) the user query into a query vector. In some embodiments, the query vector is also known as a vector embedding or a text embedding.

In some embodiments, the computer system encodes (910) the user query into the query vector using one or more trained neural networks (e.g., embedding model 210, data processing models 740, or data processing models 840), where the one or more trained neural network models are trained on a large corpus of words, sentences, and/or data visualizations.

The computer system queries (912) a semantic cache (e.g., semantic cache 110) of semantic vectors (e.g., semantic vectors 111 or vector embeddings 214) to determine one or more semantic vectors stored therein that are similar to the query vector. In some embodiments, the semantic cache is also referred to as a vector database or an embedding space. A vector database is a database that allows one to efficiently store and query embedding data. In some embodiments, the semantic cache extends the capabilities of traditional relational databases to embeddings. In some embodiments, the semantic cache stores at least 1000, 5000, 10,000, 100,000, 500,000, or over 1 million vector embeddings (e.g., vector embedding 212). A respective semantic vector is (914) a vector representation (e.g., numerical vector representation) of a previous user query and is associated with a verified response. In accordance with some embodiments of the present disclosure, the semantic cache comprises a databank of verified answers, where each answer is associated with a corresponding original user question and a respective semantic vector, as illustrated in FIG. 3. The querying includes determining (916), for each semantic vector of at least a subset of semantic vectors in the semantic cache, a respective semantic similarity score between the query vector and the respective semantic vector. In some embodiments, the respective similarity score is based on a predefined metric such as cosine similarity, Euclidean distance, or dot product.

The computer system, for each semantic vector of the at least the subset of semantic vectors in the semantic cache, determines (918) whether the respective semantic similarity score between the query vector and the respective semantic vector satisfies a first threshold score.

Referring now to FIG. 9B, in some embodiments, the computer system, in accordance with a determination (920) that the respective semantic similarity score between the query vector and the respective semantic vector satisfies a first threshold score (e.g., first threshold score is a score between 0 and 1, such as at least 0.7, at least 0.75, at least 0.8, or at least 0.85), retrieves (922) from the semantic cache a cached response corresponding to the respective semantic vector. This is also illustrated in the workflow 100 in FIG. 1.

In some embodiments, the cached response is (924) one or more of: a formula (e.g., a mathematical formula, such as SUM(Sales), or a custom calculation formula), a report, a data visualization, or a data dashboard that includes two or more data visualizations. In some instances, the cached response is a response does not change (or has minimally changes) over time. For example, the user query is for a formula and the cached response returns a formula such as “SUM(Sales)” or “MIN(Product Price,” which represents a fixed relationship between variables and remains constant regardless of the context in which it is used. In some instances, the cached response is a response that varies over time. For example, in some situations, the user query comprises a query for a visualization, such as “Show me a chart of sales for this quarter.” In this example, the sales values for a current quarter are likely to be different from those in the previous quarter. In some embodiments, in instances like these, the computer system can mask out literals and keep only the logic, such that a response “SELECT foo FROM bar WHERE date=“2024-11-30” becomes “SELECT foo FROM bar WHERE date=*,” and returns the latter (i.e., a masked version) as the verified response (e.g., cached response).

The computer system returns (926) the cached response as a response to the user query without querying the LLM.

In some embodiments, the computer system executes (928) a data visualization application, including causing display of a user interface (e.g., user interface 510) that includes one or more identifications of one or more users who have verified an accuracy of the cached response (e.g., indications 526). In some embodiments, the computer system retrieves, from the semantic cache, respective identifications of one or more users who have verified the accuracy of the cached response and causes display of the respective identifications. For example, in some embodiments, the computer system retrieves a verified answer and cites one or more users who had verified the answer (e.g., verified the accuracy of the answer). In some embodiments, the computer system also provides a respective date and/or time corresponding to when the accuracy of the cached response is verified. This is illustrated in FIG. 5B (e.g., indications 526). In some embodiments, the computer system causes display of the identifications of the one or more users (e.g., a lineage of users) who have verified the accuracy of the cached response according to a recency that the respective user has verified the response (e.g., the user(s) who verified the response most recent in time are displayed first). Advantageously, identifying users who have verified the accuracy of a response and displaying the identification of users improves user confidence that the response is a reliable response and that the computer system is not hallucinating.

The computer system, in accordance with a determination (930) that the respective semantic similarity score between the query vector and the respective semantic vector does not satisfy the first threshold score, retrieves (34), from the semantic cache, the cached response corresponding to the respective semantic vector. This is also illustrated in the workflow 100 in FIG. 1. In some embodiments, the cached response is a (question, verified answer) pair.

Referring to FIG. 9C, in some embodiments, the computer system generates (936) a prompt that includes the cached response as one of a plurality of context examples. In some embodiments, the computer system generates a prompt that includes the cached response as the only (i.e., a single) context example. In some embodiments, the plurality of context examples or the single context sample are context examples for few-shot prompting, many-shot prompting, or one-shot prompting that are provided to the LLM to help the LLM understand the task or pattern. In some embodiments, the cached response (or the one or more context examples) is appended (or included) in the prompt as part of a prompt that is generated by the computer system and input into the LLM, as illustrated in the example of FIG. 6B.

In some embodiments each context example of the plurality of context examples is (938) a cached response with a semantic similarity score that satisfies a second threshold score, wherein the second threshold score is lower than the first threshold score. For example, the first threshold score is 0.8 (or greater) whereas the second threshold score is a score between 0.7 and 0.8. This is also illustrated in the workflow 100 in FIG. 1 (e.g., step 117).

In some embodiments, the plurality of context examples includes (940) a first predefined example. Generating the prompt includes replacing the first predefined example with the cached response. For example, in some embodiments, the first predefined example is a static example (e.g., a canned example) that is included in all prompts, regardless of the domain of the user query (e.g., whether the query is from a user in marketing or engineering. Accordingly, in accordance with some embodiments disclosed herein, the computer system replaces the static example with real time domain-specific and contextually relevant examples, which in turn enables the LLM to output better responses.

In some embodiments, the computer system determines (942) a semantic similarity score between the query vector and the first predefined example. The computer system, in accordance with a determination that a semantic similarity score between the query vector and the first predefined example is lower than the respective similarity score between the query vector and the respective semantic vector, replaces (944) the first predefined example with the cached response (e.g., the semantic similarity score between the query vector and the first predefined example is 0.54 whereas the respective similarity score between the query vector and the respective semantic vector is 0.65).

In some embodiments, the computer system, prior to determining the semantic similarity score between the query vector and the first predefined example, encodes (946) the first predefined example into a first vector. Determining the semantic similarity score between the query vector and the first predefined example includes determining the semantic similarity score between the query vector and the first vector.

Referring to FIG. 9D, the computer system inputs (950) the prompt into the LLM and obtains, from the LLM, a model output. The computer system returns (952) the model output as the response to the user query.

In some embodiments, the computer system generates (954) an index (e.g., indexed semantic cache 220) based on at least a subset of semantic vectors in the semantic cache.

In some embodiments, the computer system, after returning the model output as the response to the user query, receives user verification of the model output. For example, in some embodiments, a user verifies the model output by selecting a thumbs-up affordance 518 that is displayed in a user interface 510, as illustrated in FIGS. 5A and 5B. In some embodiments, the computer system, in accordance with receiving user verification of the model output, adds (958) the query vector and the model output as an entry to the index. In some embodiments, the computer system is configured to determine, based on user selection of the thumbs-up affordance 518 and/or thumbs-down affordance 520, a freshness or staleness of the verified response. For example, the verified answers in the semantic cache 110 are associated with corresponding relevance scores 852 that can indicate a relevance, freshness, or staleness of the responses. In some embodiments, if a verified query is consistently ignored or rejected by users, then the computer system is configured to decrease its relevance score (e.g., the relevance score can be calculated from “hot ranking” algorithms). Conversely, in some embodiments, if a verified query is consistently liked or given thumbs-up by users, then the computer system is configured to increase its relevance score. In some embodiments, the computer system is configured to rank the verified responses in accordance with their respective relevance scores, and remove a respective verified response whose relevance score falls below a threshold relevance score.

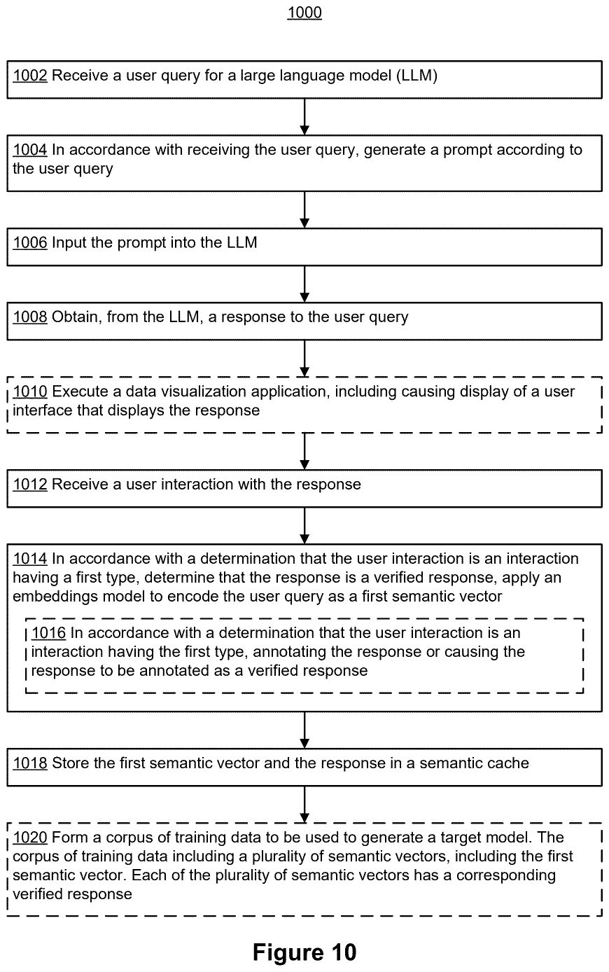

FIG. 10 provide a flowchart of an example process for generating semantic caches, in accordance with some embodiments. The method 1000 is performed at a computer system (e.g., computing device 700 or computer system 800) that includes one or more processors (e.g., processor(s) 702 or processor(s) 802) and memory (e.g., memory 706 or memory 814). The memory stores one or more programs configured for execution by the one or more processors. In some embodiments, the operations shown in FIGS. 1, 2A, 2B, 3, 4, 5A, 5B, 6A, 6B, and 9A to 9D correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1000 may be combined (e.g., with the method 900) and/or the order of some operations may be changed.

The computer system receives (1002) a user query (e.g., user utterance) for a large language model (LLM).

The computer system, in accordance with receiving the user query, generates (1004) a prompt according to the user query;

The computer system inputs (1006) the prompt into the LLM.

The computer system obtains (1008) from the LLM a response to the query.

In some embodiments, the computer system executes (1010) (or causes execution of) a data visualization application, including causing display of a user interface (e.g., user interface 510) that displays the response.

The computer system receives (1012) a user interaction with the response. For example, as illustrated in FIGS. 5A and 5B, the user can select a thumbs-up affordance 518 (e.g., an icon), a thumbs-down affordance 520 on the user interface 510. In some embodiments, the user interface can display other text such as a question as to whether the response addresses the user's query and “Yes” or “No” affordances to poll the user.

The computer system, in accordance with a determination that the user interaction is an interaction having a first type (e.g., user selects thumbs up affordance 518), determines (1014) that the response is a verified response. In some embodiments, the computer system applies an embedding model (e.g., embedding model 210) to encode the user query as a first semantic vector.

The computer system stores (1018) the semantic vector and the response in a semantic cache.

In some embodiments, the computer system forms (1020) a corpus of training data (e.g., training data 864) to be used to generate a target model. The corpus of training data includes a plurality of semantic vectors (e.g., semantic vectors 111), including the first semantic vector. Each of the plurality of semantic vectors having a corresponding verified response.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method performed at a computer system that includes one or more processors and memory, the method comprising:
in response to receiving a user query for a large language model (LLM):
encoding the user query into a query vector; and
querying a semantic cache of semantic vectors to determine one or more semantic vectors stored therein that are similar to the query vector, wherein:
a respective semantic vector is a vector representation of a previous user query and is associated with a verified response; and
the querying includes determining, for each semantic vector of at least a subset of semantic vectors in the semantic cache, a respective semantic similarity score between the query vector and the respective semantic vector;
in accordance with a determination that the respective semantic similarity score between the query vector and the respective semantic vector satisfies a first threshold score:
retrieving, from the semantic cache, a cached response corresponding to the respective semantic vector; and
returning the cached response as a response to the user query without querying the LLM; and
in accordance with a determination that the respective semantic similarity score between the query vector and the respective semantic vector does not satisfy the first threshold score:
retrieving, from the semantic cache, the cached response corresponding to the respective semantic vector;
generating a prompt that includes the cached response as one of a plurality of context examples;
inputting the prompt into the LLM and obtaining, from the LLM, a model output; and
returning the model output as the response to the user query.

2. The method of claim 1, further comprising:
generating an index based on at least a subset of semantic vectors in the semantic cache.

3. The method of claim 2, further comprising:
after returning the model output as the response to the user query, receiving user verification of the model output; and
in accordance with receiving the user verification, adding the query vector and the model output as an entry to the index.

4. The method of claim 1, wherein returning the cached response as a response to the user query without querying the LLM includes:
executing a data visualization application, including causing display of a user interface that displays one or more identifications of one or more users who have verified an accuracy of the cached response.

5. The method of claim 1, wherein each context example of the plurality of context examples is a cached response with a semantic similarity score that satisfies a second threshold score, wherein the second threshold score is lower than the first threshold score.

6. The method of claim 1, wherein:
the plurality of context examples includes a first predefined example; and
generating the prompt includes replacing the first predefined example with the cached response.

7. The method of claim 6, further comprising:
determining a semantic similarity score between the query vector and the first predefined example; and
in accordance with a determination that a semantic similarity score between the query vector and the first predefined example is lower than the respective similarity score between the query vector and the respective semantic vector, replacing the first predefined example with the cached response.

8. The method of claim 7, further comprising:
prior to determining the semantic similarity score between the query vector and the first predefined example, encoding the first predefined example into a first vector;
wherein determining the semantic similarity score between the query vector and the first predefined example includes determining the semantic similarity score between the query vector and the first vector.

9. The method of claim 1, wherein the cached response is one or more of: a formula, a report, a data visualization, or a data dashboard that includes two or more data visualizations.

10. The method of claim 1, wherein the user query specifies one or more data fields of a data source.

11. The method of claim 1, further comprising encoding the user query into the query vector using one or more trained neural networks, wherein the one or more trained neural network models are trained on a large corpus of words, sentences, and/or data visualizations.

12. A computer system, comprising:
one or more processors; and
memory coupled to the one or more processors, the memory storing one or more programs configured to be executed by the one or more processors, the one or more programs including instructions for:
in response to receiving a user query for a large language model (LLM):
encoding the user query into a query vector; and
querying a semantic cache of semantic vectors to determine one or more semantic vectors stored therein that are similar to the query vector, wherein:
a respective semantic vector is a vector representation of a previous user query and is associated with a verified response; and
the querying includes determining, for each semantic vector of at least a subset of semantic vectors in the semantic cache, a respective semantic similarity score between the query vector and the respective semantic vector;
in accordance with a determination that the respective semantic similarity score between the query vector and the respective semantic vector satisfies a first threshold score:
retrieving, from the semantic cache, a cached response corresponding to the respective semantic vector; and
returning the cached response as a response to the user query without querying the LLM; and
in accordance with a determination that the respective semantic similarity score between the query vector and the respective semantic vector does not satisfy the first threshold score:
retrieving, from the semantic cache, the cached response corresponding to the respective semantic vector;
generating a prompt that includes the cached response as one of a plurality of context examples;
inputting the prompt into the LLM and obtaining, from the LLM, a model output; and
returning the model output as the response to the user query.

13. The computer system of claim 12, the one or more programs including instructions for:
generating an index based on at least a subset of semantic vectors in the semantic cache.

14. The computer system of claim 13, the one or more programs including instructions for:
after returning the model output as the response to the user query, receiving user verification of the model output; and
in accordance with receiving the user verification, adding the query vector and the model output as an entry to the index.

15. The computer system of claim 12, wherein the instructions for returning the cached response as a response to the user query without querying the LLM include instructions for:
causing display of a user interface, including that includes one or more identifications of one or more users who have verified an accuracy of the cached response.

16. The computer system of claim 12, wherein each context example of the plurality of context examples is a cached response with a semantic similarity score that satisfies a second threshold score, wherein the second threshold score is lower than the first threshold score.

17. The computer system of claim 12, wherein:
the plurality of context examples includes a first predefined example; and
the instructions for generating the prompt include instructions for replacing the first predefined example with the cached response.

18. The computer system of claim 17, the one or more programs further including instructions for:
determining a semantic similarity score between the query vector and the first predefined example; and
replacing the first predefined example with the cached response in accordance with a determination that a semantic similarity score between the query vector and the first predefined example is lower than the respective similarity score between the query vector and the respective semantic vector.

19. A method of generating semantic caches, performed at a computer system that includes one or more processors and memory, the method comprising:
receiving a user query for a large language model (LLM):
in accordance with receiving the user query:
generating a prompt according to the user query;
inputting the prompt into the LLM; and
obtaining from the LLM a response to the user query;
receiving a user interaction with the response; and
in accordance with a determination that the user interaction is an interaction having a first type:
applying an embeddings model to encode the user query as a first semantic vector; and
storing the first semantic vector and the response in a semantic cache.

20. The method of claim 19, further comprising:
forming a corpus of training data to be used to generate a target model, the corpus of training data including a plurality of semantic vectors, including the first semantic vector, each of the plurality of semantic vectors having a corresponding verified response.
